(19) United States
(12) Patent Application Publication
(10) Pub. No.: US 2014/0219873 A1
(43) Pub. Date: Aug. 7, 2014

(54) GASIFIER IN ISO CONTAINER

(71) Applicant: How Kiap Gueh, Singapore (SG)

(72) Inventor: How Kiap Gueh, Singapore (SG)

(21) Appl. No.: 14/159,914

(22) Filed: Jan. 21, 2014

(30) Foreign Application Priority Data
Jan. 21, 2013 (SG) 201300505-3

(51) Int. Cl. C01B 3/02

(52) U.S. Cl. CPC C01B 3/02
USPC 422/109; 29/428

(57) ABSTRACT

The application provides a containerized gasifier plant. The containerized gasifier plant comprises a first ISO container having an interior, an exterior, and a primary container volume defined by the outer dimensions of the container; and a second ISO container having an interior, an exterior, and a secondary container volume defined by the outer dimensions of the container. A gasifier is placed within the primary container volume of first ISO container and an electric power supply unit is placed within the secondary container volume of second ISO container. The containerized gasifier plant further comprising at least one electric power supply cable apparatus electrically in communication between electric power supply unit and gasifier, and, a cooling tower device placed within first ISO container, second ISO container, or in combination, configured to be in operational communication with at least a portion of electric power supply unit so as to provide temperature regulation of at least a portion of electric power supply unit.

### CROSS-REFERENCE TO RELATED APPLICATIONS

This application claims priority to Singapore Application No. 201300505-3, filed Jan. 21, 2013, which is incorporated by reference herein in its entirety.

### TECHNICAL FIELD AND BACKGROUND

The invention relates to a method for the production of a crude synthesis gas that contains CO and H2.

Synthesis gases are gas mixtures that are used in synthesis reactions and consist predominantly of carbon monoxide and hydrogen. For some CO/H2 combinations, special designations such as water gas, cracked gas, methanol synthesis gas, or oxo gas have established themselves, based on their origin or their use. Synthesis gas can serve as a starting substance mixture for the production of liquid fuels. For example, synthesis gas is used in the Fischer-Tropsch process, to produce diesel fuel. Gasoline fuels can be produced using the MTG (methanol to gasoline) process, in which the synthesis gas is first converted to methanol, which is later converted to gasoline, in further method steps.

Fundamentally, all carbonaceous substances can be used for synthesis gas production. These include not only the fossil fuels coal, petroleum, shale ore, tar sands, and natural gas, but also other starting materials such as plastics, peat, discarded rubber, wood or other biomass, such as municipal or agricultural wastes, for example.

If solids are used, these must first be shredded, in complicated manner, so that a crude synthesis gas can be produced by means of partial oxidation or steam cracking Afterwards, the crude synthesis gas is processed in further steps. All of these measures lead to high investment costs, which are a barrier for the production of liquid fuels from synthesis gas.

The crude synthesis gas produced using the method according to the invention can be used in different production methods. For example, it can be used for the production of fuels, within the scope of a Fischer-Tropsch process. Likewise, it can be used within the scope of methanol synthesis. The methanol can then be converted to gasoline, according to the MTG process. Also, it is possible that the synthesis gas is converted to SNG (synthetic natural gas). Likewise, the synthesis gas that is produced can be used for oxo synthesis or for ammonia production.

### TERMS AND DEFINITIONS

A “gasifier,” as defined herein, refers to a reaction environment wherein a carbon carrying feedstock material is converted into a gas through the action of heat and, possibly, one or more reactive gases such as oxygen, air, carbon dioxide (CO2), and/or steam. Gasifier can mean partial oxidation gasifier, a steam reformer, an autothermal reformer, and combinations thereof. Gasifier can mean a downdraft-type gasifier, an entrained-flow type gasifier, a fluidized bed gasifier, a molten metal gasifier, a plasma-type gasifier, or combinations or derivatives thereof

“Synthesis gas,” or “syngas,” as defined herein, generally refers to a mixture of carbon monoxide (CO) and hydrogen (H2) produced by gasification in a gasifier.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value. In some instances, the term about can denote a value within a range of ±10% of the quoted value.

Terms “heating value,” “calorific value,” “caloric value,” are interchangeably used within this description.

“Feed”, “feed fuel”, “feedstock”, as used herein throughout the specification and claims, may refer to coal, biomass, municipal solid waste (MSW), refuse-derived fuel (RDF), industrial waste, sewage, raw sewage, peat, scrap rubber, shale ore, tar sands, crude oil, natural gas, low-BTU blast furnace off-gas, flue gas exhaust, or a combination thereof.

Refuse-derived fuel (RDF), which is generally produced by shredding municipal solid waste, consists largely of organic components of municipal waste such as plastics and biodegradable waste. Non-combustible materials such as glass and metals are removed mechanically and the resultant material compressed into pellets, bricks, or logs and used for conversion to combustible gas, which can itself be used for electricity generation or the like.

“Feed”, “feed fuel”, “feedstock”, as used herein throughout the specification and claims, can also mean agricultural feedstocks, forestry-based feedstocks, municipal solid waste (MSW), MSW can include the following: selected from the group consisting of waste plastics, used tires, paper, scrap-wood, food-processing waste, sewage, sludge, green-waste.

“Feed”, “feed fuel”, “feedstock”, as used herein throughout the specification and claims can also mean fossil material such as crude oil, tar sands, shale oil, coal, natural gas, and combinations thereof,

“Feed”, “feed fuel”, “feedstock”, as used herein throughout the specification and claims, can also mean coal mine tailings, coal waste, coal fines, coal-water slurry, coal-liquid mixtures, and combinations thereof.

“Feed”, “feed fuel”, “feedstock”, as used herein throughout the specification and claims, can also mean refinery residual material comprises low-value carbonaceous by-products selected from the group consisting of asphaltenes, tars, and combinations thereof

Flue gas exhaust also refers to gas containing CO, CO.sub.2 (carbon dioxide), nitrogen, nitrogen oxides and other particulates, sulphur compounds, soot, tar, or combustion exhaust gases generated from fossil-fuel power plants such as oil, coal, gas-fired powerplants, boilers, steam generators, combustion burners, gas turbine exhausts, reciprocating engine exhaust gases.

Coal refers to a common fossil fuel, the most common classification is based on the calorific value and composition of the coal.

Coal is of importance as a fuel for power generation now and in the future since there are a lot of coal reserves, and the coal reserves are hardly unevenly distributed over the world.

ASTM (American Society for Testing and Materials) standard D388 classifies the coals by rank. This is based on properties such as fixed carbon content, volatile matter content, calorific value and agglomerating character.

Broadly, the coals can be categorized as “high rank coal” and “low rank coal,” which denote high-heating-value, lower ash content and lower heating value, higher ash content coals, respectively.

Low-rank coals include lignite and sub-bituminous coals. These coals have lower energy content and higher moisture levels.

High-rank coals, including bituminous and anthracite coals, contain more carbon than lower-rank coals and correspondingly have a much higher energy content. Some coals with intermediate properties may be termed as “medium rank coal.”

The term biomass covers a broad range of materials that offer themselves as fuels or raw materials and are characterized by the fact that they are derived from recently living organisms (plants and animals).

This definition clearly excludes traditional fossil fuels, since although they are also derived from plant (coal) or animal (oil and gas) life, it has taken millions of years to convert them to their current form.

Thus the term biomass includes feeds derived from material such as wood, woodchips, sawdust, bark, seeds, straw, grass, and the like, from naturally occurring plants or purpose grown energy crops.

It includes agricultural and forestry wastes. Agricultural residue and energy crops may further include husks such as rice husk, coffee husk etc., maize, corn stover, oilseeds, cellulosic fibers like coconut, jute, and the like.

Agricultural residue also includes material obtained from agro-processing industries such as deoiled residue, gums from oil processing industry, bagasse from sugar processing industry, cotton gin trash and the like. It also includes other wastes from such industries such as coconut shell, almond shell, walnut shell, sunflower shell, and the like.

In addition to these wastes from agro industries, biomass may also include wastes from animals and humans.

In some embodiments, the biomass includes municipal waste or yard waste, sewage sludge and the like. In some other embodiments, the term biomass includes animal farming byproducts such as piggery waste or chicken litter. The term biomass may also include algae, microalgae, and the like.

Thus, biomass covers a wide range of material, characterized by the fact that they are derived from recently living plants and animals. All of these types of biomass contain carbon, hydrogen and oxygen, similar to many hydrocarbon fuels; thus the biomass can be used to generate energy, biomass includes components such as oxygen, moisture and ash and the proportion of these depends on the type and source of the biomass used.

“Refinery residual,” or “refinery resid,” as defined herein, generally refers to the heaviest by-product fractions produced at a refinery. Asphaltenes are a type of refinery resid, as is coker coke.

“ISO container”, “standard container”, as used herein throughout the specification and claims, mean ISO freight shipping containers that are available world-wide at reasonable cost. Standard ISO containers have lengths of 20 ft (6.1 m), 40 ft (12.2 m), 45 ft (13.7 m), 48 ft (14.6 m), and 53 ft (16.2 m). The standard 20, 40, 48, and 53 ft containers have an external width of 8 ft, an external height of 8 ft 6 in, an internal width of 7 ft 8 in, and an internal height of 7 ft 9 in. The 45 ft container is a “high-cube” container having an external height of 9 ft 6 in. The 40 ft container is available as a normal height container with a height of 8ft 6 in and as a high-cube container with a height of 9 ft 6 in. The 20 ft container is the most common container worldwide, but the 40 ft container is increasingly replacing it, particularly since costs tend to be per container and not per unit of container length. The longer container types are also becoming more common, especially in North America. ISO containers are designed for standardized transportation on trucks, ships, and trains, and the containers also may be shipped conveniently by barge and airplane

### SUMMARY

This invention relates to a containerized gasifier plant for the gasification of cellulosic biomass, coal and other types of carbonaceous feed to produce low BTU syngas for downstream application such as electric power generation, or chemical upgrading into one or more determined syngas-derived product.

Generally, gasifiers have reaction environments that are operating at a range starting from hundreds of degrees Celsius to more than 1600 degrees Celsius, and are usually thermally insulated from the exterior of the gasifier to reduce or minimize thermal loss.

In many gasifiers, there are also inlet and outlet conduits that carry and deliver fluids such as slurried feed, oxidant gas, steam, etc into and out from the gasifier's reaction environment, in another embodiment, the feed is delivered with an oxidant gas such as air, oxygen, oxygen-enriched air, or a mixture into the inlet sections of the gasifier.

In some other gasifiers, the supply of electricity at high voltages is required, such as plasma-equipped gasifiers, or gasifiers employment some form of electromagnetic induction heating coil or apparatus.

The present invention comprises of at least 2 standard ISO containers, the primary ISO container and the secondary ISO container, whereby the primary ISO container houses at least one gasifier unit and a conduit trunk device that carry one or more inlet, outlet conduits to and from the primary ISO container to the secondary ISO container.

In one aspect of the present invention, the secondary ISO container comprises of at least one electric power supply unit, and at least a set of power supply cables that are electrically connected from the at least one electric power supply unit in the secondary ISO container to the gasifier that is housed within the primary ISO container. In another aspect of the present invention the set of power supply cables are housed within an enclosed conduit truck that is operationally connected between the primary and secondary ISO containers.

In another aspect of the present invention the primary ISO container is divided by means of at least one bulkhead wall section that defines and forms a enclosure within primary ISO container wherein the gasifier is placed within the said enclosure. In another aspect of the present invention the secondary ISO container has a cooling tower device that is configured to provide temperature regulation to the power supply unit housed within said secondary ISO container.

In another aspect of the present invention the primary ISO container is placed with a cooling tower device that is configured to provide a coolant fluid for regulating at least a portion of the gasifier housed within said primary ISO container.

In another variation to the present invention, a primary ISO container is placed in an operating site, and a secondary ISO container is placed and stacked onto the top proximate area of the primary ISO container. Electric cable connection from either ISO containers are routed by a conduit trunk configured to provide some structural support to the electrical cables of electric cable connection within the interior space of either ISO container to each other, so as to electrically connect the power supply unit and gasifier.

### BRIEF DESCRIPTION OF THE DRAWINGS

FIG. 1 illustrates the primary and secondary ISO container in accordance to the present invention.

FIG. 2 illustrates the primary and secondary ISO container with the gasifier unit housed within and in operational communication with a power supply unit via a power conduit trunk placed between primary and secondary ISO containers.

FIG. 3 shows the schematic layout of a non-limiting example of a cooling device configured to provide temperature regulation to at least a portion of the electric power supply of the present invention.

FIG. 4 illustrates an example of a gasifier placed within primary, secondary ISO containers.

FIGS. 5, 6, 7 show another view of the present invention.

FIG. 8 illustrates a non-limiting example of an electric power supply unit configured to provide a gasifier with electric power.

FIG. 9 illustrates another non-limiting example of a variation of the present invention.

### EXAMPLES, EMBODIMENTS, & DISCLOSURE

### Example 1

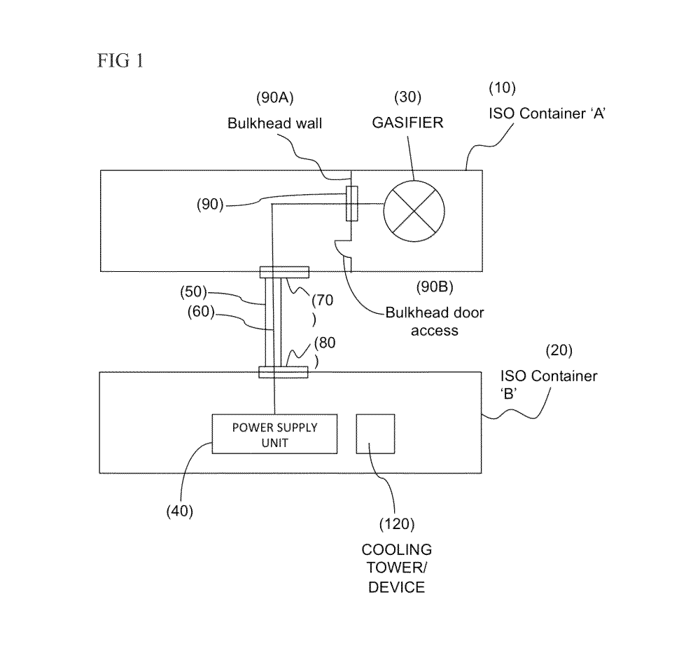

With reference to FIG. 1, primary ISO container (10) is provided with secondary ISO container (20), a gasifier (30) is placed within primary ISO container (10), ISO container (10) is further configured with an access opening (70), while ISO container (20) is configured with access opening (80). A conduit apparatus (50) links access opening (70) and (80), and is arranged to hold or carry at least one cable set (60) that provides electrical connection between the gasifier (30) and a electric power supply unit (40).

The conduit (50) is arranged and configured to accommodate for thermal cycling especially when ISO containers (20), (10) are placed outdoors. In some operating sites, environmental temperature can vary from 40 degrees Celsius in daylight, to −10 degrees Celsius during the night, various other climatic conditions such as sand-storms, ice, can cause pre-mature cracking or damage to the surrounding shield of the at least one cable set (60).

In one embodiment, the conduit (50), or the electric cable (60), or in combination, is configured with one or more electric heating apparatus to maintain the operating temperature of the cable set (60) to within a desired temperature range, in other embodiments, the conduit (50) access openings (70) and (80), the electric cable set (60), or a combination are covered with an insulating material such as a refractory blanket that allows a desired level of thermal insulation.

In one embodiment, the conduit (50) is configured to be at proximate to the lower bottom area of ISO containers (10), (20). In other embodiments, conduit (50) is placed at the proximate upper top roof area of ISO containers (10), (20).

In one embodiment, at least one gasifier is placed within either ISO container (10), or (20), or in some other embodiment, a plurality of gasifiers are placed within ISO container (10), or (20), or a combination.

In one embodiment, the conduit (50) is replaceable, by means of attachment devices at either access openings (70), (80), or both, in yet another embodiment of the present invention, conduit (50) has at least a portion of its body, or access openings (70) (80) having at least a portion of its body to be made of a flexible material to allow for thermal expansion and contraction of the electric cable set (60), conduit (50), or both.

### Example 2

With reference to FIG. 1, an electric power supply unit (40) is provided in secondary ISO container (20), which is configured to receive electricity from a selected power source (not shown), the electric cable set (60) is electrically connected from the power supply unit (40) to the gasifier (30) via conduit (50) that is attached between access openings (70) and (80). A bulkhead wall (90A) is arranged to separate the gasifier (30) from the remainder interior space within ISO container (10).

Safety compliance and various construction directives such as those involving pressurized gas appliance, such as the gasifier (30), related gas compressors, pumps and devices (not shown), will require the bulkhead wall (90A). A bulkhead access hatch (90B) is provided to allow for routine maintenance of the gasifier (30).

### Example 3

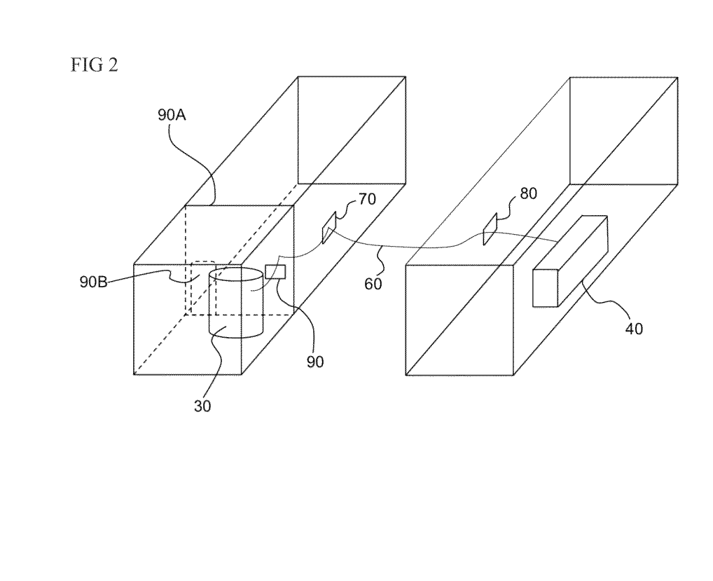

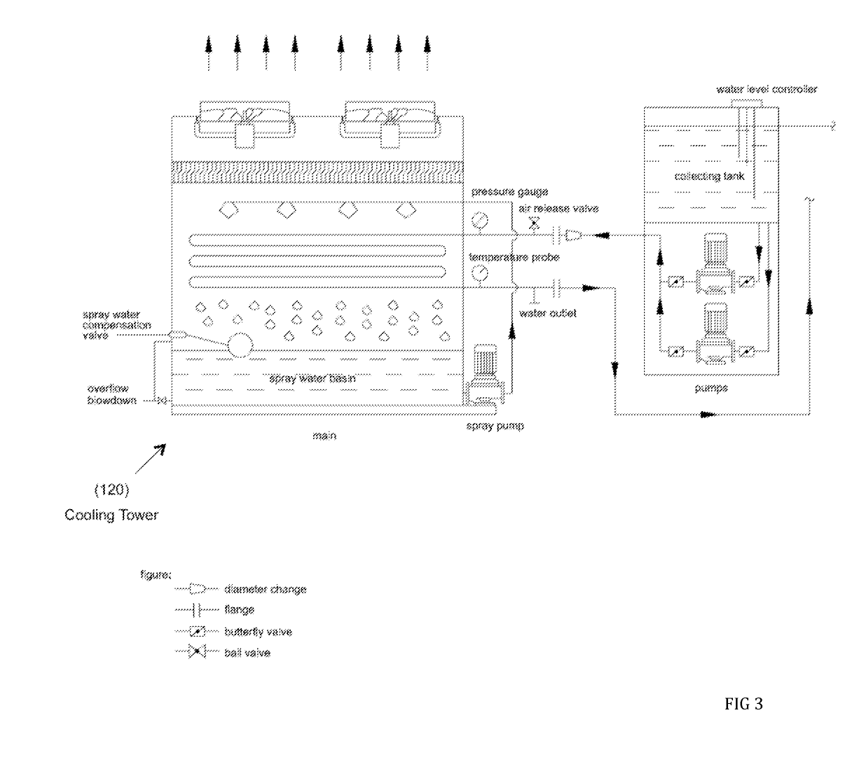

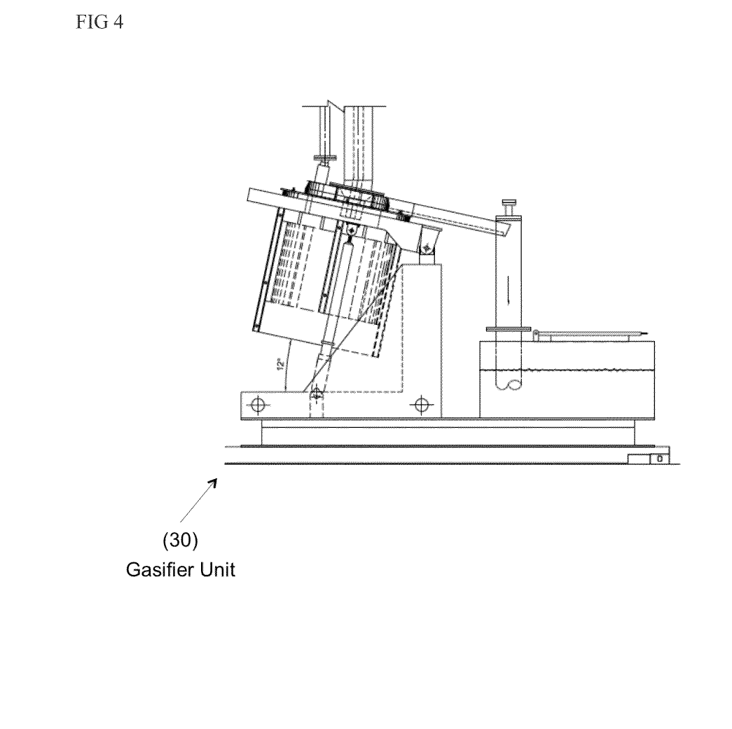

With reference to FIG. 1, FIG. 2 and FIG. 3, electric power supply unit (40) similar to the example described in EXAMPLE 1 and 2, is further configured with at least one cooling device (120) of FIG. 1, a more detailed schematic is shown in FIG. 3. The cooling device (120) is further configured to circulate a fluid such as a gas, or a liquid, such as water, or de-ionized water, or mineral oil, or combinations thereof, to flow and be in in-direct fluid contact or exchange between identified portions of the electric power supply unit (40) to regulate the operating temperature of the supply unit (40). Such portions may include voltage, current transformers, semiconductor components, capacitors, etc.

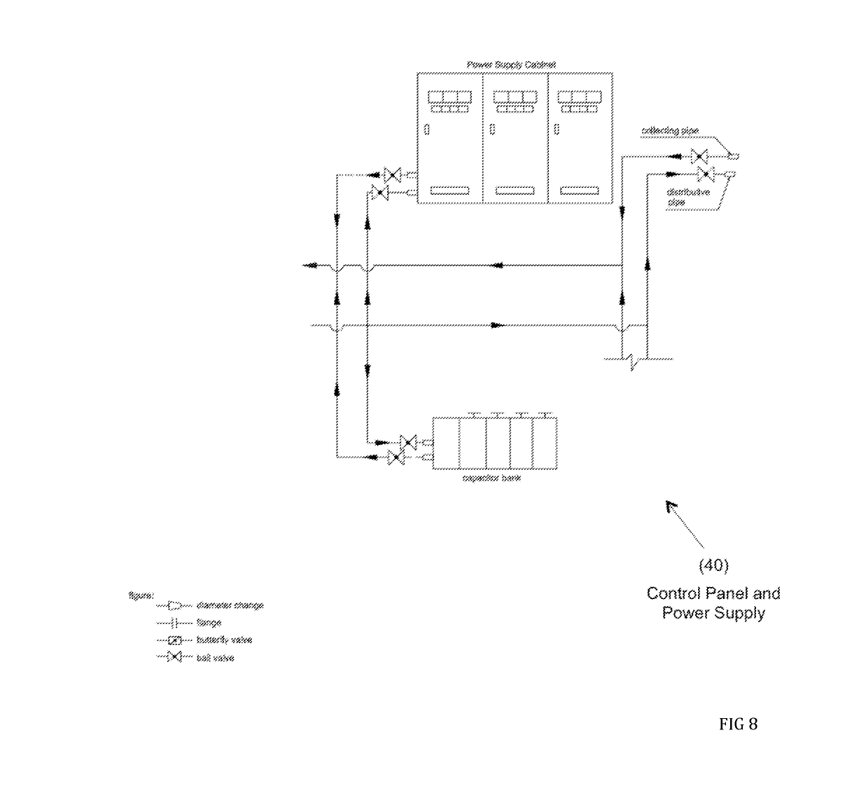

With reference to FIG. 3, an evaporative water-spray type of cooling device is depicted for cooling device (120), in other embodiments (not shown), the cooling device (120) may vary in design and methodology deployed to perform cooling and heat exchange of the circulating cooling fluid that is utilized and intended to regulate the operating temperature of the electric power supply unit (40). A more detailed schematic of a typical electric power supply unit (40) is illustrated in FIG. 8.

### Example 4

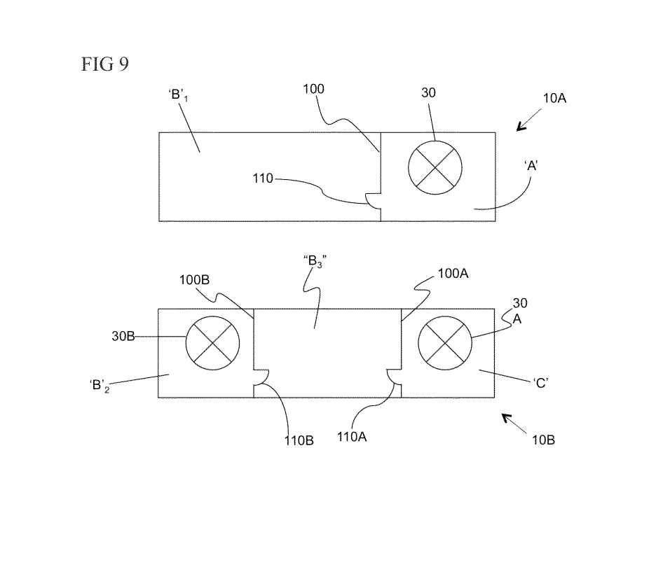

With reference to FIG. 9, ISO container 10A is configured and placed with a vertical bulkhead wall 100 that forms interior space “A”, and interior space “B1” within ISO container 10A, at least one gasifier 30 is placed within interior space “A”, “B1”, or a combination.

In the case of a plasma-equipped gasifier, a gasifier having one or more electric induction coil, or another gasifier type requiring a source of electricity (either AC, or DC voltage, or AC, DC current), the gasifier 30, is electrically connected to a electric cable set (60) (not shown in FIG. 9, but is shown in FIG. 1), and electric cable set (60) is configured and placed within a protective conduit that is similarly arranged in accordance to the example described in EXAMPLE 1.

In another variation of the present invention, and with reference to FIG. 9, ISO container 10B is configured with bulkhead 100A forming interior space “C”, while bulkhead 100B is configured to form interior space “B2” and “B3”. Gasifiers 30A and 30B are placed within their respective interior space formed of “C” and “B2”. The electric power supply (40) of FIG. 1 may be placed within the interior space of “B3” and one or more electric cable set (60) of FIG. 1 may be electrically connected and in communication with either gasifier 30A, 30B, or both. Electric power supply (40) may be connected to gasifiers 30A, 30B in parallel, or in a series electrical circuit arrangement.

### Example 5

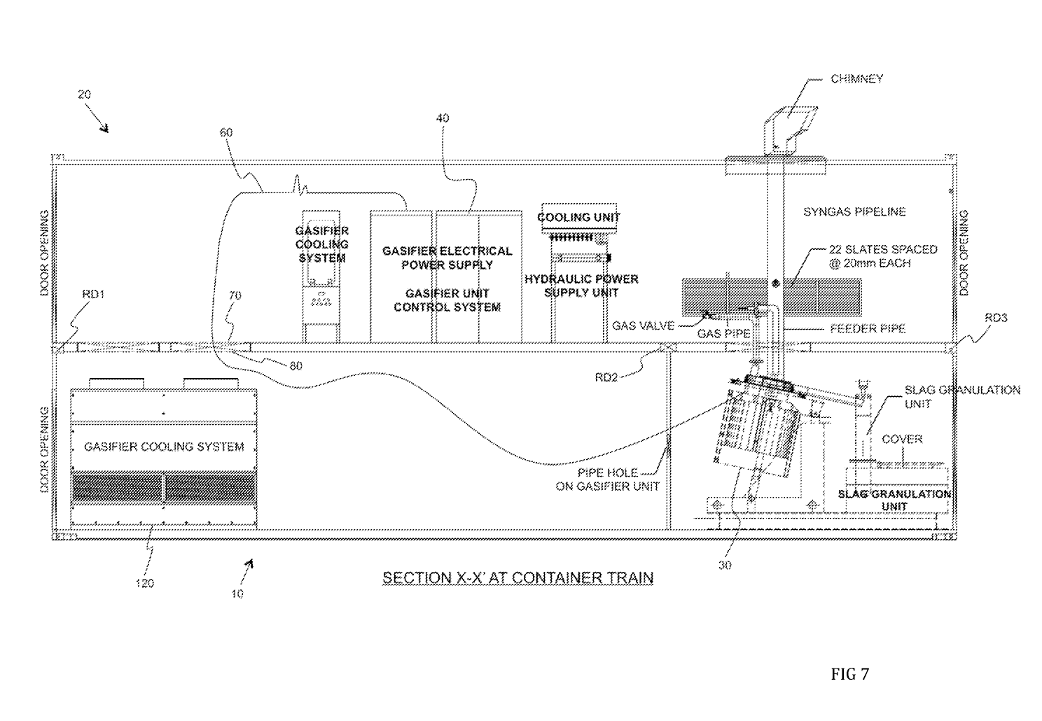

With reference to FIG. 7, primary ISO container 10 is installed and placed a gasifier 30, and cooling device 120. For electrical and general operational safety, the electric power supply unit 40 is placed in secondary ISO container 20.

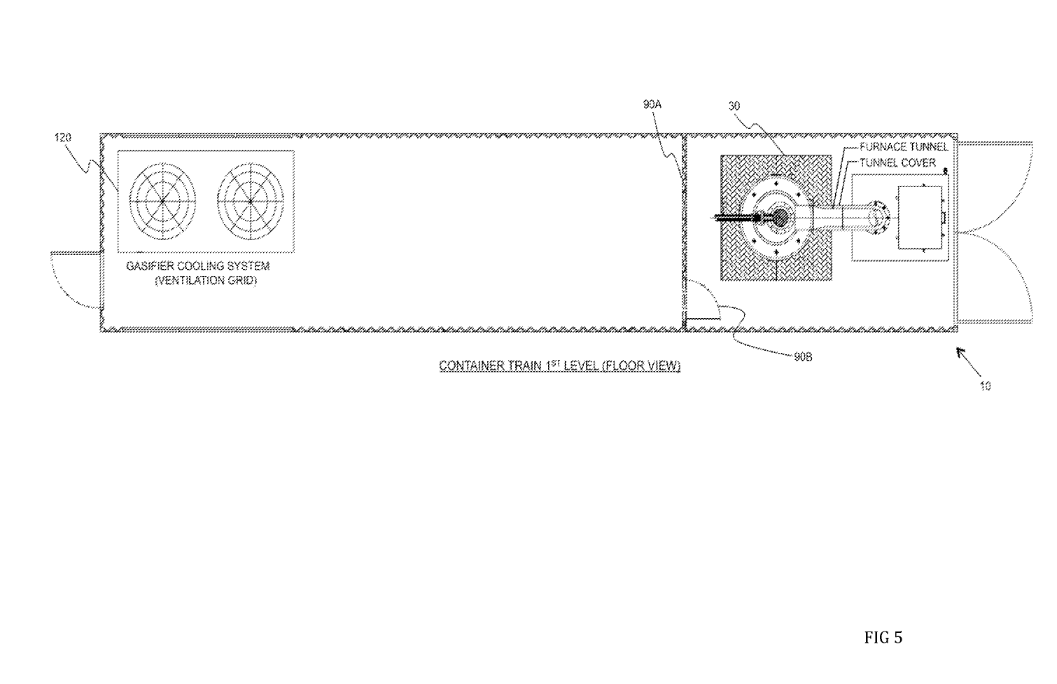

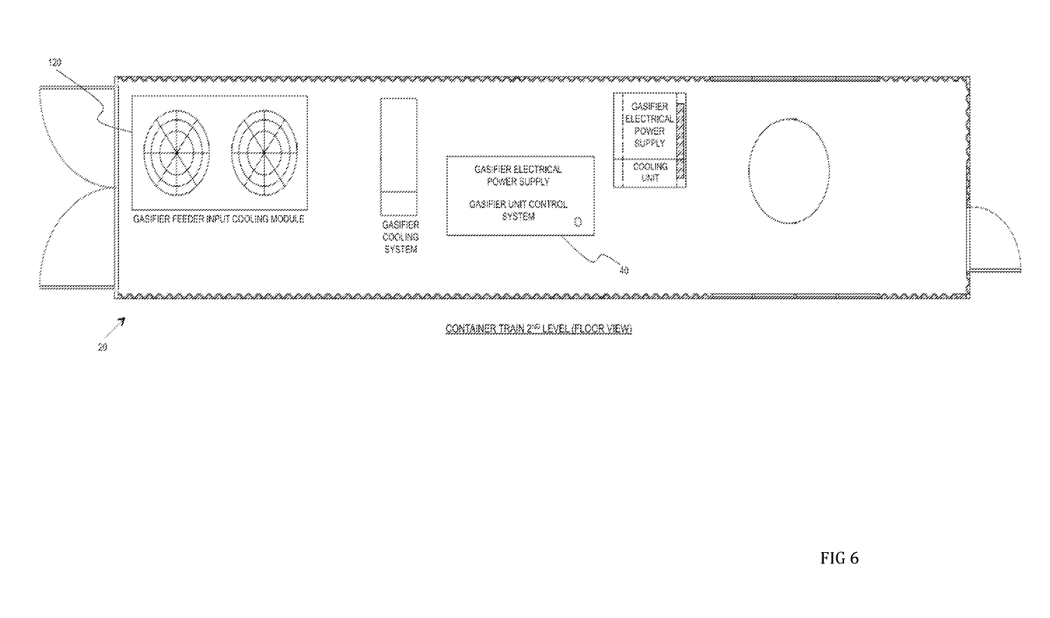

While ISO containers 10, 20 may be placed in the orientation such as the one depicted in FIG. 1, FIG. 5, FIG. 6, with reference to FIG. 7, the secondary ISO container 20 is placed on top of the primary ISO container 10, eliminating the need for the electric cable set 60 to be exposed to the exterior of either ISO container 10, or 20.

In one aspect of the present embodiment, access opening 70, 80 are arranged to allow for cable set 60 to be running through from ISO container 10 to ISO container 20, wherein cable 60 is structurally supported with one or more structural members attached to the interior wall surface of ISO container 10, ISO container 20, or both.

In another deviation of the present invention, and with reference to FIG. 7, cooling device 120 may be placed within ISO container 10. In yet another deviation of the present invention and with reference to FIG. 7, cooling device 120 may be placed in ISO container 20 instead, if the vibration tolerance of the electric power supply unit 40 is within a desired range.

In yet another deviation of the present invention and with reference to FIG. 7, rubberized or shock adsorbing pads or apparatuses RD1, RD2, RD3 are placed in a manner that reduces the vibrational effects between ISO container 10, and ISO container 20 during operation of the containerized gasifier plant. This is especially useful if the containers 10, 20 are stacked on top of each other. In yet another embodiment, active vibration suppression is used for the electric power supply unit.

In a further aspect, the present application discloses a method for assembling and manufacturing of a containerized gasifier plant. The containerized gasifier plant, which comprises a first ISO container and a second ISO container, is assembled at an assembly site. Therein the first ISO container has installed one or more components of the containerized gasifier plant the components comprising at least one gasifier. At the assembly site, the at least one gasifier is assembled and positioned in one of the ISO containers, and fixed inside the ISO container. Furthermore, a cooling tower device is assembled, positioned in at least one of the ISO containers, and in the ISO container.

The containerized gasifier plant, which comprises the first ISO container and the second ISO container, is assembled at an operating. Herine, the second ISO container has installed one or more components of the containerized gasifier plant, the one or more components comprising at least one electric power supply unit with at least one set of electric power supply cable.

At the operating site, the first ISO container and the second ISO container are placed in proximity to each other. This means they are either stacked on top of each other or they are placed so closely that they can be connected with a power cable that is placed inside a conduit between the first ISO container and the second ISO container. The at least one set of electric power supply cable is configured to be electrically in operational communication between at least one electric power supply unit and at least one gasifier and the cooling tower device is configured to be in operational communication with at least a portion of the electric power supply unit so as to provide temperature regulation of at least a portion of the electric power supply unit.

Furthermore, the completed containerized gasifier plant is transported from the assembly site to the operating site, unloaded and commissioned on the operating site. This comprises, among others, connecting utilities comprising an electric power supply source to the at least one electric power supply unit, and various piping works adapted to provide product syngas from at least one gasifier to a product syngas consuming equipment placed at the operating site.

The embodiments can also be described with the following lists of elements being organized into items. The respective combinations of features which are disclosed in the item list are regarded as independent subject matter, respectively, that can also be combined with other features of the present specification.

1. A containerized gasifier plant, comprising:

(a) a first ISO container having an interior, an exterior, and a primary container volume defined by the outer dimensions of the container; and

(b) a second ISO container having an interior, an exterior, and a secondary container volume defined by the outer dimensions of the container;

wherein a gasifier is placed within the primary container volume of the first ISO container and an electric power supply unit is placed within the secondary container volume of the second ISO container; further comprising

(1) at least one electric power supply cable apparatus electrically in communication between the electric power supply unit and the gasifier,

(2) and, a cooling tower device placed within the first ISO container, the second ISO container, or in combination, configured to be in operational communication with at least a portion of the electric power supply unit so as to provide temperature regulation of at least a portion of the electric power supply unit.

2. Containerized gasifier plant according to item 1, wherein the first ISO container and the second ISO container are arranged side-by-side and wherein the electric power supply cable apparatus comprises a conduit between the second ISO container and the first ISO container, the gasifier comprising an induction coil, and wherein power cables of the electric power supply cable apparatus are arranged within the conduit.

Herein, “side-by-side” means that the containers are not stacked on top of each other but is not limited with respect to the relative orientation of the containers.

3. Containerized gasifier plant according to item 2, wherein the conduit between the first ISO container and the second ISO container is in fluid communication with the cooling tower device.

4. Containerized gasifier plant according to item 3, wherein the conduit and/or power cables of the electric power supply cable apparatus are provided with an electric heating apparatus, the electric heating apparatus being powered by the electric power supply.

5. Containerized gasifier plant according to item 3, wherein at least part of the conduit and/or of power cables of the electric power supply cable apparatus are covered by an insulating material.

6. Containerized gasifier plant according to item 1, wherein the ISO containers are stacked on top of each other.

7. Containerized gasifier plant according to item 1, wherein the gasifier is enclosed by the first ISO container and by a bulkhead wall that extends from one lateral side to an opposite lateral side of the first ISO container.

8. Containerized gasifier plant according to item 1, wherein the cooling tower comprises an exterior cooling circuit and an interior cooling circuit, the exterior cooling circuit being in operational communication with at least a portion of the electric power supply unit, the interior cooling circuit being provided for cooling a cooling fluid of the exterior cooling circuit.

This configuration is shown in FIG. 3 of the present specification, wherein the connections to the exterior cooling circuit are shown as interrupted lines, a supply connection being connected to a cooling fluid outlet and a backflow connection being connected to a collection tank for the cooling fluid of the exterior cooling circuit. In the example of FIG. 3 the cooling fluids of the inner and the outer cooling circuit are water.

9. Containerized gasifier plant according to item 8, wherein the exterior cooling circuit comprises meandering ducts, the meandering ducts being arranged within a casing of the interior cooling circuit, the interior cooling circuit comprising a spraying unit for spraying the meandering ducts with a cooling fluid of the interior cooling circuit.

10. Containerized gasifier plant according to item 1, wherein the second ISO container is stacked on top of the first ISO container, a cooling tower of the cooling tower device being provided in the first ISO container, the containerized gasifier plant comprising a hydraulic power supply unit for adjusting a tilt angle of a crucible of the gasifier, the hydraulic power supply unit being in thermal contact with a portion of the cooling tower device.

In one embodiment, the hydraulic power supply is provided in the second ISO container, a duct extending from the hydraulic power supply unit through an opening in a top wall of the first ISO container to a tilting lever of the gasifier. Thereby, the hydraulic fluid does not get as hot when the hydraulic power supply is placed away from the gasifier in the second container.

11. Containerized gasifier plant according to item 10, wherein a top wall of the first ISO container comprises a first exhaust duct opening and a top wall of the second ISO container comprises a second exhaust duct opening, an exhaust duct of the gasifier extending through the first exhaust duct opening and the second exhaust duct opening.

12. Containerized gasifier plant according to item 1, wherein the gasifier comprises an induction coil and wherein the cooling tower device is in operational communication with the induction coil.

For example, if a hollow induction coil is provided, cooling may be realized by circulating a cooling fluid through the induction coil.

13. Containerized gasifier plant according to item 1, wherein a crucible of the gasifier comprises ducts, the ducts of the crucible being in operational communication with the cooling tower device.

14. Containerized gasifier plant according to item 1, wherein the first ISO container is provided with a first gasifier and a second gasifier, the electric power supply unit being connecting in parallel or in series to the first gasifier and the second gasifier.

15. Containerized gasifier plant according to item 14, wherein the first gasifier and the second gasifier are placed at opposite ends of the first ISO container, the first gasifier being enclosed by the first ISO container and a first bulkhead wall and the second gasifier being enclosed by the first ISO container and a second bulkhead wall.

16. Method for installation and manufacturing of a containerized gasifier plant, comprising:
assembling a containerized gasifier plant at an assembly site wherein the containerized gasifier plant comprises a first ISO container and a second ISO container; the first ISO container having installed one or more components of the containerized gasifier plant further comprising at least one gasifier,

and
configuring at least one set of electric power supply cable to be electrically in operational communication between at least one electric power supply unit and at least one gasifier,
transporting the completed containerized gasifier plant from assembly site to an operating site, unloading the completed containerized gasifier plant and commissioning the completed containerized gasifier plant on the operating site, including connecting utilities comprising an electric power supply source to the at least one electric power supply unit, and various piping works adapted to provide product syngas from at least one gasifier to a product syngas consuming equipment placed at operating site.

17. Method for installation and manufacturing of a containerized gasifier plant, comprising:
assembling said containerized gasifier plant at an operating site wherein the containerized gasifier plant comprises a first ISO container and a second ISO container; the second ISO container having installed one or more components of the containerized gasifier plant further comprising at least one electric power supply unit having at least one set of electric power supply cable,
configuring at least one set of electric power supply cable to be electrically in operational communication between at least one electric power supply unit and at least one gasifier.

That which is claimed is:

1. A containerized gasifier plant, comprising:
a first ISO container having an interior, an exterior, and a primary container volume defined by the outer dimensions of the container; and
a second ISO container having an interior, an exterior, and a secondary container volume defined by the outer dimensions of the container;
wherein a gasifier is placed within the primary container volume of the first ISO container and an electric power supply unit is placed within the secondary container volume of the second ISO container; further comprising
at least one electric power supply cable apparatus electrically in communication between the electric power supply unit and the gasifier; and
a cooling tower device placed within the first ISO container, the second ISO container, or in combination, configured to be in operational communication with at least a portion of the electric power supply unit so as to provide temperature regulation of at least a portion of the electric power supply unit;
wherein the cooling tower device comprises an exterior cooling circuit and an interior cooling circuit, the exterior cooling circuit being in operational communication with at least a portion of the electric power supply unit, the interior cooling circuit being provided for cooling a cooling fluid of the exterior cooling circuit.

2. Method for installation and manufacturing of a containerized gasifier plant, comprising:
assembling a containerized gasifier plant at an assembly site wherein the containerized gasifier plant comprises a first ISO container and a second ISO container; the first ISO container having installed one or more components of the containerized gasifier plant, the one or more components comprising at least one gasifier, wherein the assembling at the assembly site comprises:
assembling the at least one gasifier, positioning the at least one gasifier in one of the ISO containers, and fixing the at least one gasifier inside the ISO container; and
assembling a cooling tower device, positioning the cooling tower device in at least one of the ISO containers, and fixing the cooling tower device in the at least one of the ISO container;
assembling said containerized gasifier plant at an operating site wherein the containerized gasifier plant comprises the first ISO container and the second ISO container; the second ISO container having installed one or more components of the containerized gasifier plant, the one or more components comprising at least one electric power supply unit having at least one set of electric power supply cable, the assembling of the containerized gasifier plant at the operating site comprising:
placing the first ISO container and the second ISO container in proximity to each other;
configuring at least one set of electric power supply cable to be electrically in operational communication between at least one electric power supply unit and at least one gasifier;
configuring the cooling tower device to be in operational communication with at least a portion of the electric power supply unit so as to provide temperature regulation of at least a portion of the electric power supply unit;
transporting the completed containerized gasifier plant from the assembly site to the operating site, unloading the completed containerized gasifier plant and commissioning the completed containerized gasifier plant on the operating site, including connecting utilities comprising an electric power supply source to the at least one electric power supply unit, and various piping works adapted to provide product syngas from at least one gasifier to a product syngas consuming equipment placed at the operating site.
